(19) United States
(12) Patent Application Publication
(10) Pub. No.: US 2016/0257621 A1
(43) Pub. Date: Sep. 8, 2016

(54) PLANT GROWTH ACCELERATOR AND MANUFACTURING METHODS THEREOF

(71) Applicant: POSTECH ACADEMY-INDUSTRY FOUNDATION, Pohang-si (KR)

(72) Inventors: Yoon-Seok Chang, Pohang-si (KR); Hakwon Yoon, Jeju-si (KR); Jaehwan Kim, Pohang-si (KR); Inhwan Hwang, Pohang-si (KR); Youngjun Oh, Pohang-si (KR)

(73) Assignee: POSTECH ACADEMY-INDUSTRY FOUNDATION, Pohang-si (KR)

(21) Appl. No.: 14/963,193

(22) Filed: Dec. 8, 2015

(30) Foreign Application Priority Data
Mar. 3, 2015 (KR) 10-2015-0029741

(51) Int. Cl. C05D 9/02; C05G 3/00

(52) U.S. Cl. CPC C05D 9/02; C05G 3/0041

(57) ABSTRACT

The present invention relates to a method for increasing carbon assimilation of a plant, and thereby for increasing a biomass, and more specifically, to a fertilizer which can increase carbon assimilation of the plant and thereby increase biomass, and manufacturing method thereof.

A plant growth accelerator according to the present invention includes a nano zerovalent iron. When the plant is exposed to the nano zerovalent iron, stomata of leaves are increased, carbon assimilation is increased and thus biomass is increased.

### PRIORITY CLAIM

This application claims priority to Korean Application No. 10-2015-0029741, filed on Mar. 3, 2015, which is incorporated by reference in its entirety.

### TECHNICAL FIELD

The present invention relates to methods which increase carbon dioxide assimilation and thereby, can increase biomass, and more specifically relates to a fertilizer which increases carbon dioxide assimilation of a plant and thereby, which can increase biomass, and the manufacturing methods thereof.

### BACKGROUND ART

Ever since an acceleration of an increasement of carbon dioxide concentration in the air has been found as a major cause of a climate change, an active movement which reduces carbon dioxide to counteract a climate change is occurred in the world. Carbon generated on the land occupies the largest part of all global carbon flux, and a land plant except for a marine plankton is the only living organism which can remove carbon dioxide.

In particular, carbon dioxide-reduction technology using the plant has a high research and development value as a low carbon green technology of a resource circulation-type concept which can use it as an energy source after converting into biomass in addition to an advantage of the reduction of greenhouse gases, but since there is no data which can calculate a design factor in a field, its application is very limited.

Most of researches removing carbon dioxide with the plant is focused on a genetically modified plant which can regulate an open and shut of stomata. Because the only organ which a gas exchange is occurred in the plant is the stomata surrounded with guard cells.

There are various factors regulating the open and shut of the stomata. Among these, an activity of plasma membrane (PM) H⁺-ATPase called as a Proton pump is correlated with the open phenomenon of the stomata. It is well known that if an activity of PM H⁺-ATPAse of leaves is increased, guard cells swell up and thus the stomata becomes bigger. In addition, a gene such as AHA2 (ARABIDOPSIS H⁺-ATPASE 2) among isoform proteins of such H⁺-ATPase has been founded as a major gene playing a role of the open and shut of stomata among the isoform proteins.

### DISCLOSURE

### Technical Problem

An object sought to be solved in the present invention is to provide a new fertilizer which can promote a growth of the plant and manufacturing methods thereof.

Other object sought to be solved in the present invention is to provide a new fertilizer which facilitates carbon assimilation by regulating the open and shut of stomata and thereby, can increase the biomass, and the manufacturing methods thereof.

Also, another object sought to be solved in the present invention is to provide methods facilitating the growth of the plant by using the fertilizer comprising the materials which can facilitate carbon assililation by regulating the open and shut of stomata.

### Technical Solution

To accomplish the above-mentioned objects, the plant growth accelerator according to the present invention is characterized in comprising nano zerovalent iron (nZVI) as an effective ingredient.

In the present invention, a term, ‘growth’ means an increasement of carbon rate of the plant and/or absolute carbon amount (dry sample weight×carbon rate).

In the present invention, a term, ‘enhancement’ means that the growth is increased to 10% or more, preferably 20% or more, more preferably 30% or more, the most preferably 50% or more by administrating the plant growth accelerator under the same condition when comparing it with a control.

In the present invention, it is understood that a term ‘nano’ means that the diameter is in the range of 1˜1000 nm, preferably 5˜500 nm, more preferably 10˜100 nm.

In the present invention, it is understood that the said term, ‘soil’ means an environment matrix supporting a root of the plant, and means a ground including soil and/or water.

In the present invention, said growth accelerator increases H⁻-ATPase activity of the plasma membrane of the plant, and increase an expression of the gene of AHA2 among isoforms of H⁺-ATPase to faciliate the growth of the plant.

The nano zerovalent iron according to the present invention is a common nanosized zero valent iron (hereinafter, referred as nZVI) which can be used as a donor as a nanosized iron particle.

Any nZVI can be used, including a commercial nZVI for environment purification, as well as the core-shell-structure of nano iron including α-Fe and having iron oxide on its surface. In addition, the nano zerovalent iron can have a dissimilar metal, for example, nano particles such as nickel, copper, paladium and the like.

In the present invention, the nano zerovalent iron can be used as being mixed with the soil, it is preferable that its concentration in the soil is 0.01˜5.0 g/kg of the soil, preferably 0.1˜0.5 g/kg of the soil.

In the present invention, any of plants can be included as long as the plant is faciliated by nano zerovalent iron. More exactly, plants wherein its stomata are expanded by nano zerovalent iron can be included, and in particular, plants wherein AHA2 of the plant is overexpressed and/or the activity of H⁺-ATPase in the plant is increased are included.

The plants are plant species of non-graminaceous plants such as rice, cucumber, tomato, Arabidopsis, and preferably, Arabidopsis being Herbaceous plants.

In one embodiment, the present invention provides a method for facilitating the growth of the plant by adding a nano zerovalent iron to a rooting zone of the plant, preferably, to the soil where the plant is vegetated.

In one embodiment, the present invention provides a method for over-expressing AHA2 of the plant by adding a nano zerovalent iron to a rooting zone of the plant, preferably, to the soil where the plant is vegetated.

In one embodiment, the present invention provides a method for increasing the activity of H⁺-ATPase of plasma membrane in the plant by adding a nano zerovalent iron to a rooting zone of the plant, preferably, to the soil where the plant is vegetated.

In one embodiment, the present invention provides the method for lowering the iron availability of the plant by adding a nano zerovalent iron to a rooting zone of the plant, preferably, to the soil where the plant is vegetated.

In one embodiment, the present invention provides a method for increasing biomass by placing nano particles emitting electrons on the rooting zone of the soil in whichx the plant is vegetated to lower iron availability of the plant.

### Advantageous Effects

According to the present invention, the carbon assimilation the plant, for example, Arabidopsis can be simply increased by pouring nano zerovalent iron into the soil in the proper concentration, and thereby, the biomass of the plant is increased. When comparing it with the control which grows in the soil without pouring nZVI, it was observed that the biomass and the size of the leaves were increased to about 1.5 and 1.6 times through experiments, respectvely.

### DESCRIPTION OF DRAWINGS

FIG. 1 represents photographs of stomata and the size comparison for the control group and the expreimental group according to the present invention, photographs of stomata for the control group (left) and the experimantal group (right) (control group (grown in the soil stirred with nZVI)).

FIG. 2 represents H+-ATAase activity of an aerial part (leaves) of the plant according to the present invention and the amounts of AHA2 gene expression as determined by qRT-PCT.

FIG. 3 represents the phenotype and biomass for the control group and the experimental group according to the present invention.

FIG. 4 represents the leaf phenotype and size for the control group and the experimental group.

FIG. 5 represents the carbon ratio of the control group and the experimental group.

FIG. 6 represents the iron content ratio in the dry samples of the control group and the experimental group.

### BEST MODE FOR INVENTION

Hereinafter, an explanation of the present invention will be described in detail via Examples. It is obvious to the person having ordinary knowledge in the art that these examples are to specifically explain the present invention, and the scope of the present invention is not to be limited to these examples.

### EXAMPLE 1

### Preparation of the Experimental Materials

Commercially used RNIP (Toda, Japan) was used as nZVI, a gardener's bed soil was used as the soil, and tap water was used for water needed for the plant cultivation.

### EXAMPLE 2

### Preparation of the Soil Stirred with nZVI

0.1 g of nZVI was washed with ethanol and degased/deionized water, and stirred with 85 g of the dry soil, and 115 ml of the tap water. Seeds of Arabidopsis were seeded in the above soil, and cultivated by using plant growth chamber under the below growth condition for three (3) weeks.

2-1. Growth Condition

Day/Night: 16/8 h

Temperature: 23˜24° C.

Huminity: 30-40%

### EXAMPLE 3

### Comparison of the Sizes of Stomata, Plasma Membrane H⁺-ATPase Activity Degree and Expression Amounts of AHA2 Gene

3-1. Size of Stomata

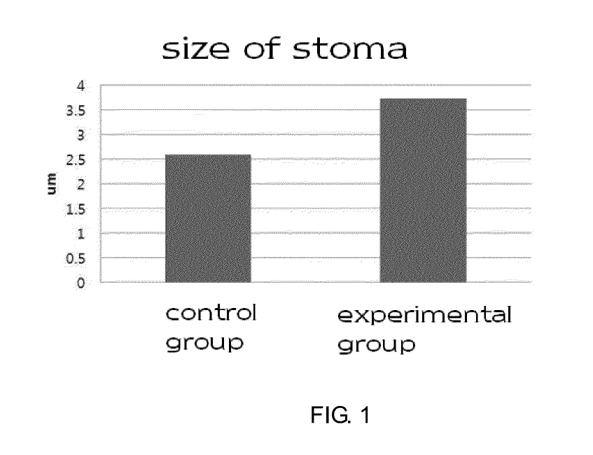

Epidermal cells of the underside of leaves of the plant cultivated for three weeks were striped and the size thereof was determined with fluorescent microscope (Zeiss Axioplan). It could be identified from FIG. 1 that stomata of Arabidopsis cultivated on the soil stirred with nZVI was greater than that of the control.

3-2. Comparison of H⁺-ATPase Activity and AHA2 Gene Expression Amounts

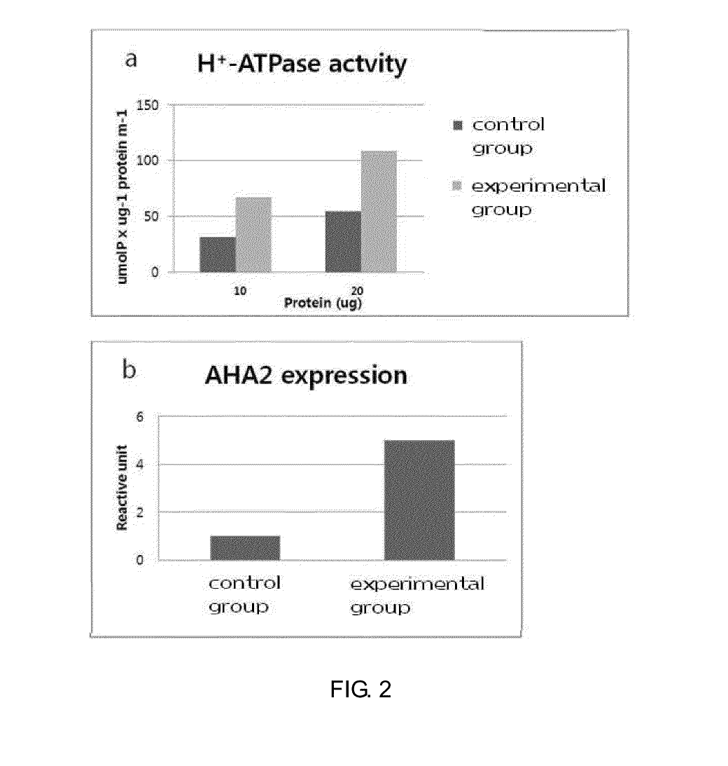

After preparing protoplast with leaves of the plant cultivated for three weeks, a pumping out activity of H⁺-ATPase was determined with it (FIG. 2a). Also, AHA2 expression amounts were compared by using Quantitative real-time PCR (qRT-PCT) and RNeasy plant mini kit (Qiagen, USA) (FIG. 2b).

### EXAMPLE 4

### Analysis of the Plant

4-1. Biomass

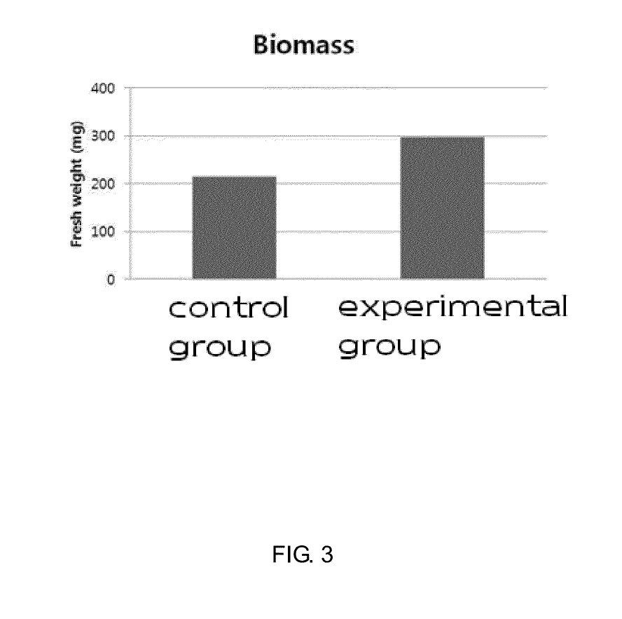

A fresh weight of the plant cultivated for three weeks was determined. A measure of weight was performed for shoot part except for a root of the plant. A mean weight for 10 models in each group was determined, and was repeatedly practiced three times. As a result, it could be identified that the weight of the plant cultivated on nZVI was increased to about 1.5 times over that of the control, as represented in FIG. 3.

4-2. Size of Leaves

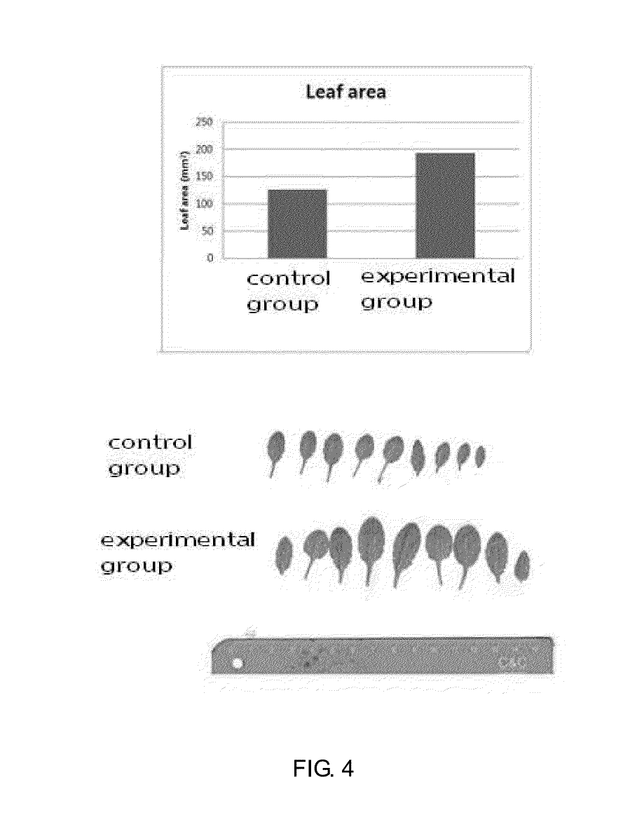

The size of leaves was determined with Image J program and the number of leaves was fifty. A phenotype and measurement value of leaves were represented in FIG. 4.

4-3. Increase of Carbon Assimilation

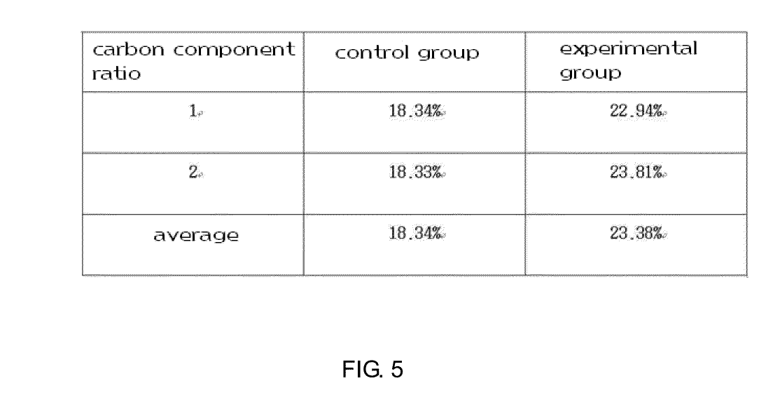

Carbon assimilation was analyzed with stability isotope Ratio Mass Spectrometer (IsoPrime-EA, UK), and it was identified that carbon isotope ratio (δ) of the Arabidopsis cultivated on the soil stirred with nZVI was become smaller. It was corresponded to the fact that when photosynthesis activity was higher, 12C which is lighter than 13C is increasingly entered and thus δ value is smaller. In addition, carbon ratios for dry samples were determined with Elemental Analyzer (Flash EA 1112, USA) and compared to each other. Referring to FIG. 5, it can be identified that the carbon ratio is increased over that of the control, meaning that the carbon assimilation is increased.

4-4. Analysis of Iron Atom in the Plant

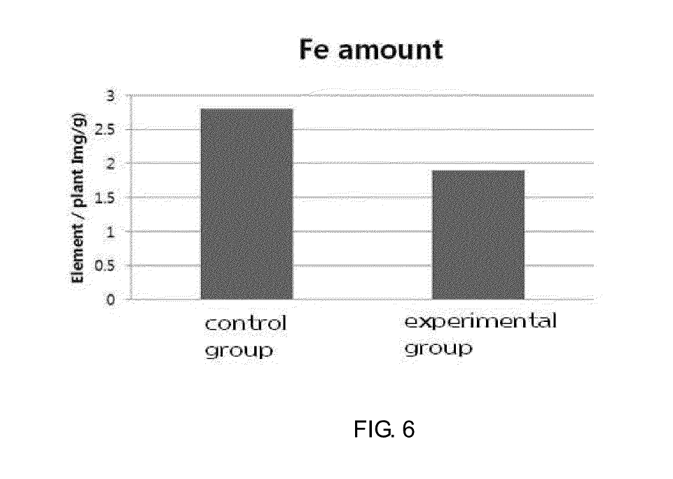

A result of the analysis for iron component of the dry sample is depicted in FIG. 6. Shoot part of the plant cultivated for three weeks except for the root was washed with flowing water and dried in the oven of 80° C. for 10 hours or more. The sample was ground with a grinder and poured into 2 ml of nitric acid (60%) and completely dissolved at the temperature of 105° C. with a heat block. After then, a concentration of iron component was determined with ICP-AES (Thermo. USA). From the result, the concentration of iron of the plant grown in the soil stirred with nZVI was low, as depicted in FIG. 6. From this, it could be identified that nZVI lowered the iron solubility of the plant.

Without being limited by theory, the major role of H⁺-ATPase in the plant is making acidification of rooting zone by blowing hydrogen ion (H⁺ in the root to help the uptake of iron which is not soluble, but when nZVI, as a solid form surrounded with oxide, which can not be directly used by the plant, is present in the rooting zone, the electrons emitted from nZVI dissolve the water to generate OH⁻ and thus lower the solubility of iron ion. As a result, in order to overcome the solubility of iron lowered due to nZVI in the plant, the activity of plasma membrane H⁻-ATPase was become higher.

In the invention of the present application, as depicted in FIG. 2, such increase of plasma membrane H⁺-ATPase activity was appeared on the aerial part of the plant, more correctly, leaf part of the plant, in addition to the root part which was already known in the art, and thus, it was identified that AHA2, isotype gene which was closely connected with the activity of H⁺-ATPase, was over-expressed (Santi et al., New Phytol. 2009, 183, 1072). According to the recent study of Academic world, it has been proven that AHA2 gene is an important factor inducing the stomata opening phenomenon of plasma membrane H⁺-ATPase (Wang et al., Proc. Natl. Acad. Sci. USA 2014, 111, 533). This was identifzied in FIG. 1 that the experimental group has stomata greater than that of the control group.

As above, while the specific part of the present invention has been described in detail, such specific description is only the preferable illustrative embodiments, and it is obvious that the scope of the invention is not to be restricted by such embodiments. Therefore, it is to be considered that the substantial scope of the present invention is defined by the attached claims and equivalents thereof.

1. A plant growth accelerator which is characterized in comprising a nano zerovalent iron (nZVI), as an effective ingredient.

2. The plant growth accelerator according to claim 1, which is characterized in that the nono zerovalent iron is a core-shell form.

3. The plant growth accelerator according to claim 1, which is characterized in that a concentration of nono zerovalent iron in the soil is 0.01˜5.0 g/kg of the soil.

4. The plant growth accelerator according to claim 1, which is characterized in that the growth accelerator increases H⁻-ATPase activity of plasma membrane of the plant.

5. The plant growth accelerator according to claim 1, which is characterized in that the growth accelerator increases the expression of AHA2 gene.

6. The plant growth accelerator according to claim 1, which is characterized in that the plant is non-graminaceous plants.

7. The plant growth accelerator according to claim 6, which is characterized in that the plant is Arabidopsis.

8. The plant growth accelerator according to claim 1, which is characterized in that the plant growth accelerator is placed on the rooting zone of the plant.

9. A method for growing a plant, which is characterized in that the growth of the plant is facilitated by adding a nano zerovalent iron, as an effective ingredient, to the soil wherein the plant is vegetated.

10. The method according to claim 9, which is characterized in that the concentration of the nano zerovalent iron in the soil is 0.01˜5.0 g/kg of the soil.

11. The method according to claim 9, which is characterized in that the nano zerovalent iron is inputted near the root of the plant

12. The method according to claim 9, which is characterized in that the plant is non-graminaceous plants.

13. The method according to claim 9, which is characterized in that the concentration of iron ion is lowered in the plant.

14. The method according to claim 9, which is characterized in that AHA2 is over-expressed in the plant.

15. The method according to claim 9, which is characterized in that H⁺-ATPase activity of the plasma membrane is increased in the plant.

16. The method according to claim 14 or 15, which is characterized in that AHA2 is over-expressed in aerial part of the plant and H⁺-ATPase activity of the plasma membrane is increased.

17. A method for increasing the biomass, which is characterized in that nano particles emitting electrons are placed on the rooting zone of the soil wherein the plant is vegetated to lower iron solubility of the plant and thereby to increase the biomass of the plant.
